(19) United States
(12) Patent Application Publication
(10) Pub. No.: US 2012/0038670 A1
(43) Pub. Date: Feb. 16, 2012

(54) APPARATUS AND METHOD FOR PROVIDING AUGMENTED REALITY INFORMATION

(75) Inventors: Jung-Hak CHOI, Seoul (KR); Kyu-Tae KIM, Seoul (KR); Hye-Jin KIM, Seoul (KR); Young-Jin OH, Seoul (KR); Nam-Young RYU, Paju-si (KR); Man-Jung YI, Seoul (KR); Woo-Yean JEONG, Seoul (KR)

(73) Assignee: PANTECH CO., LTD., Seoul (KR)

(21) Appl. No.: 13/168,210

(22) Filed: Jun. 24, 2011

(30) Foreign Application Priority Data
Aug. 13, 2010 (KR) 10-2010-0078461

(51) Int. Cl. G09G 5/00

(52) U.S. Cl. 345/633

(57) ABSTRACT

An apparatus, system, and method for providing augmented reality (AR) information of a concealed object are disclosed. The method for providing AR information of a concealed object by a terminal connectable to a server via a wired and/or wireless communication network may include acquiring an image of a real environment; defining a reference object included in the acquired image; obtaining image capturing position information about a position of the image and reference object recognition information of the defined reference object; transmitting the obtained image capturing position information and the reference object recognition information to the server; receiving information about concealed objects from the server, the concealed objects being disposed behind the reference object along or about a direction from the image capturing position to the reference object; and outputting the received information about concealed objects.

### CROSS-REFERENCE TO RELATED APPLICATION(S)

This application claims priority from and the benefit under 35 U.S.C. §119(a) of Korean Patent Application No. 10-2010-0078461, filed on Aug. 13, 2010, the disclosure of which is incorporated herein by reference for all purposes.

### BACKGROUND

1. Field

The following description relates to an apparatus and method for providing augmented reality information.

2. Description of the Background

Augmented reality (AR) refers to a computer graphic technique that combines virtual objects or information with an image of a real-world environment to display the virtual elements as if they were present in the real environment.

Unlike a general virtual reality technology, which provides only virtual objects in a virtual space, AR technology provides a view of reality that is blended with virtual objects, thereby providing supplementary information which is difficult to obtain in reality. In addition, the general virtual reality technology is applicable to a limited range of fields such as, game technology, whereas due to the above characteristics, AR can be applied to various fields and hence has increasingly gained attention as a future display technology suitable to a ubiquitous environment.

For example, if a tourist traveling in London views a street in a certain direction through a camera built in a mobile phone having various features, such as global positioning system (GPS), the mobile phone may display augmented reality (AR) information about the surrounding environment and objects, such as restaurants and stores having sales, along the street as an information overlay on an image of a real street captured by the camera.

In this case, since the mobile phone only provides AR information about the objects included in an image obtained by the camera, if objects that the tourist is interested in viewing are positioned behind other objects in the image, it is difficult for the tourist to obtain AR information of the concealed objects.

### SUMMARY

Exemplary embodiments of the present invention provide an apparatus and method for providing augmented reality (AR) information of a concealed object which is behind another object.

Additional features of the invention will be set forth in the description which follows, and in part will be apparent from the description, or may be learned by practice of the invention.

An exemplary embodiment provides a method for providing augmented information (AR) of a concealed object by a terminal connectable to a server via a wired and/or wireless communication network, the method including: acquiring an image of a real environment; defining a reference object included in the acquired image; obtaining image capturing position information about a position of the image and reference object recognition information of the defined reference object; transmitting the obtained image capturing position information and the reference object recognition information to the server; receiving information about concealed objects from the server, the concealed objects being disposed behind the reference object about a direction from the image capturing position to the reference object; and outputting the received information about concealed objects.

An exemplary embodiment provides a method for providing augmented reality (AR) information of a concealed object by a server connected to at least one or more terminals via a wired and/or wireless communication network, the method including: in response to receiving a concealed object information request from one of the terminals, analyzing reference object recognition information and image capturing position information received from the terminal; determining information about at least one or more concealed objects disposed behind a reference object about a direction from an image capturing position to the reference object according to the analysis result; and transmitting the determined information about the concealed objects to the terminal.

An exemplary embodiment provides an apparatus to provide augmented reality (AR) information of a concealed object, the apparatus including: an image acquiring unit to acquire an image of a real environment; a display unit to output the image and information about a concealed object; a communication unit to access a server and process a signal communicated with the server; and a control unit to define a reference object included in the image, to obtain image capturing position information about a position of the image and reference object recognition information of the defined reference object, to transmit the obtained image capturing position information and reference object recognition information to the server through the communication unit, and to receive from the server information about concealed objects present about a direction from the image capturing position to the reference object, and to output the received information about concealed objects to the display unit.

An exemplary embodiment provides a server to provide augmented reality (AR) information of a concealed object, the server including: a communication unit to process a signal communicated with at least one or more terminals via a wired and/or wireless communication network; and a control unit to, in response to receiving concealed object information request signal from the terminal through the communication unit, analyze reference object recognition information and image capturing position information received from the terminal, to determine information about at least one or more concealed objects that are disposed behind a reference object about a direction from an image capturing position to the reference object according to the analysis result, and to transmit the detected information about concealed objects to the terminal.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a communication system to provide augmented reality (AR) information according to an exemplary embodiment.

FIG. 2 is a diagram illustrating an apparatus to provide AR information according to an exemplary embodiment.

FIG. 3 is a diagram illustrating a server to provide AR information according to an exemplary embodiment.

FIG. 4 is a flowchart for a method of providing AR information according to an exemplary embodiment.

FIG. 5 is a diagram illustrating a focal point setting screen according to an exemplary embodiment.

FIG. 6 is a diagram illustrating a focal point setting screen according to an exemplary embodiment.

FIG. 7 is a diagram illustrating a user interface to provide concealed object information according to an exemplary embodiment.

FIG. 8 is a diagram illustrating a user interface to provide concealed object information according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art.

Hereinafter, “object” refers to a real object, a real person, and/or a marker or sign, which may be present in a real-world environment. In addition, “visible object” refers to an object that can be recognized from an image captured from a real environment, and generally refers to an object present in reality, such as a building, a person, a mountain, and the like. “Concealed object” refers to a real object which cannot be recognized from the image captured from a real environment since the object is placed behind another visible object. The above terms may be modified according to the purpose and practice of a user or an operator, and thus the definition of the above terms should be made based on contents throughout the specification.

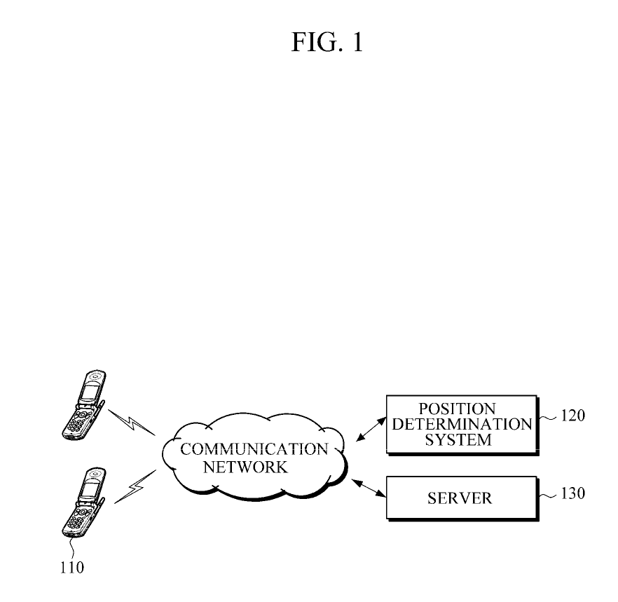

FIG. 1 is a diagram illustrating a communication system to provide augmented reality (AR) information according to an exemplary embodiment.

Referring to FIG. 1, the communication system may include at least one or more apparatuses 110 (hereinafter, referred to as “terminals”) to provide AR information and a server 130 (hereinafter, referred to as “server”) 130 to provide AR information for an AR service to the terminals 110, and the terminals 110 and the server 130 are connected to each other via a wired and/or wireless communication network. In addition, each terminal 110 may be provided with its position information from a position determination system 120 through the communication network.

The terminals 110 may be applicable to any types of apparatuses which can recognize an object included in an image and display AR information corresponding to the recognized object, and the apparatuses may include mobile communication terminals, such as personal digital assistants (PDAs), smart phones, and navigation terminal devices, and personal computers, such as desktop computers and laptop computers.

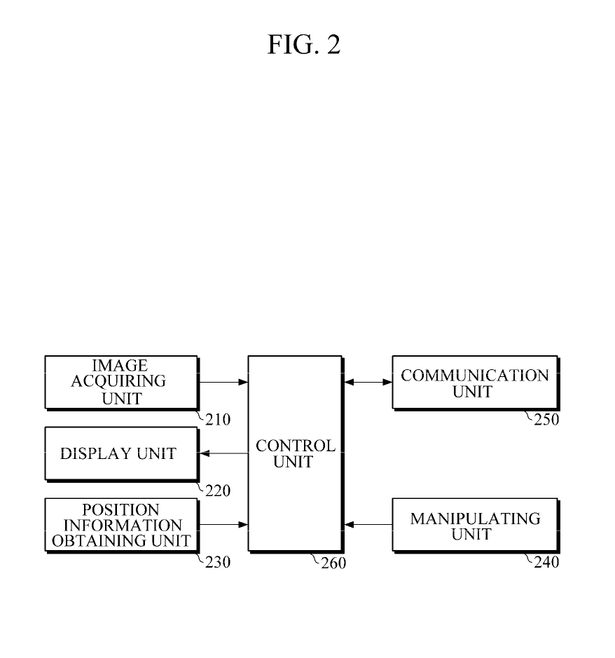

FIG. 2 is a diagram illustrating an apparatus or terminal to provide AR information according to an exemplary embodiment.

The terminal may include an image acquiring unit 210, a display unit 220, a position information obtaining unit 230, a control unit 260, a manipulating unit 240, and a communication unit 250.

The image acquiring unit 210 acquires an image by capturing a real environment image, and outputs the image to the control unit 260. The image acquiring unit 210 may be a camera or an image sensor. In addition, the image acquiring unit 210 may be a camera that is capable of zooming in/out an image or being rotated automatically or manually by the control of the control unit 260. However, aspects are not limited thereto such that the image acquiring unit 210 may acquire an image of a real environment from an outside source or from a memory. The display unit 220 outputs an image input from an external source, and for example, in FIG. 2, the display unit 220 may output at least one of the image obtained by the image acquiring unit 210, a focal point setting screen, concealed object information, user interface information, or AR information of an object of interest, and combinations thereof. The position information obtaining unit 230 may receive position information of the terminal 110 from the position determination system 120, and output the position information, and may include, for example, a global positioning system (GPS) receiver to receive a position information signal from a GPS satellite and/or a system to receive a position information signal(s) from a communication network.

The manipulating unit 240, which is a user interface, may receive information from a user, and may include a key input unit that creates key information upon pressing a key button, a touch sensor, a mouse, a touchscreen, and/or the like. In the example, the manipulating unit 240 may receive at least one of a concealed object information request signal, reference object selection information, and object of interest selection information. The communication unit 250 may process a signal received from the outside through the wired and/or wireless communication network and output the processed signal to the control unit 260, and may process an internal output signal received from the control unit 260 such that the signal can be transmitted to the outside through the wired and/or wireless communication network.

The control unit 260 may control the above elements to provide AR information of a concealed object, and may be a hardware processor or a software module to be executed on such a hardware processor.

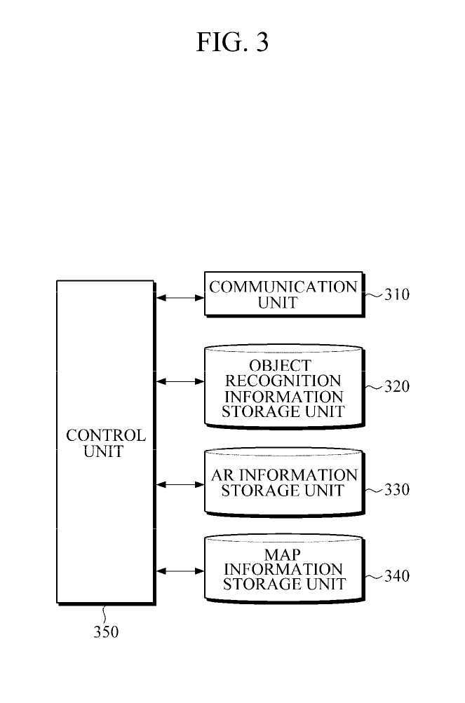

FIG. 3 is a diagram illustrating a server to provide AR information according to an exemplary embodiment.

The server may include a communication unit 310, an object recognition information storage unit 320, an AR information storage unit 330, a map information storage unit 340, and a control unit 350.

The communication unit 310 may process a signal received from the outside through a wired and/or wireless communication network and output the processed signal to the control unit 350, and may process an inner output signal received from the control unit 350 such that the signal can be transmitted to the outside through the wired and/or wireless communication network. The object recognition information storage unit 330 may store recognition information for recognizing objects, and, for example, may store properties, such as outlines and colors of the objects. Accordingly, the control unit 350 may identify an object by comparing properties contained in object recognition information received from the terminal and properties contained in the object recognition information stored in the object recognition storage unit 320.

The AR information storage unit 330 may store pieces of AR information that are related to an object. For example, if an object is a given tree, the AR information storage unit 330 may store a name of the tree, a habitat, ecological characteristics, etc. as tag images. The map information storage unit 340 may store map information. In response to receiving position information from a terminal, the control unit 350 may detect or determine map information corresponding to the received position information from the map information storage unit 340.

The control unit 350 may control the above described elements to provide AR information of a concealed object, and may be a hardware processor or a software module to be executed on such a hardware processor.

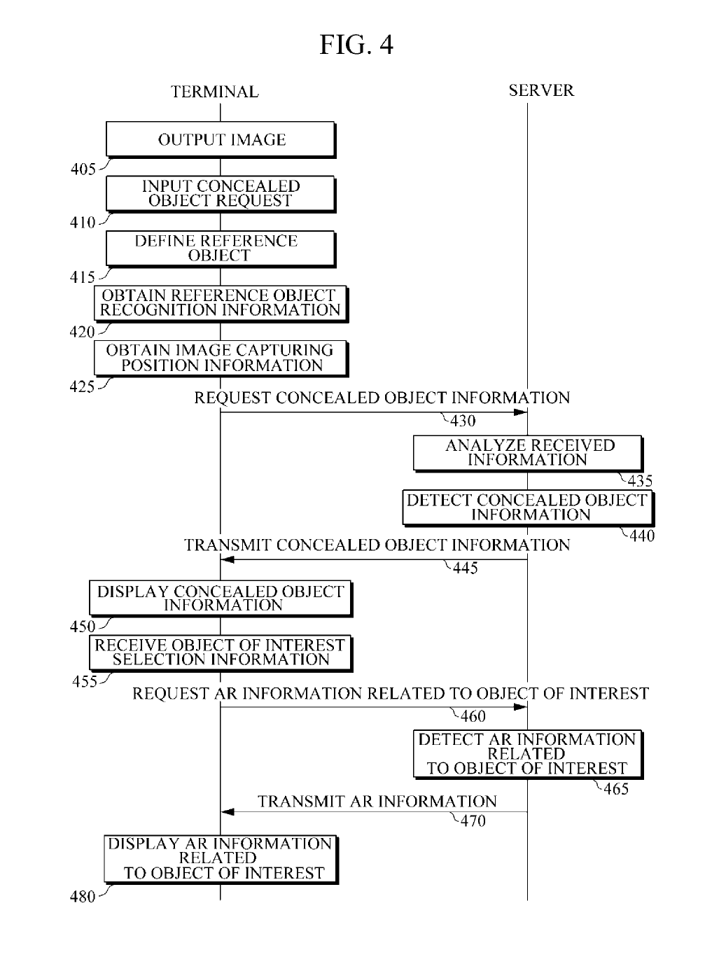

An example of a method for providing AR information of a concealed object by the system as described above will now be described with reference to FIGS. 4 to 8.

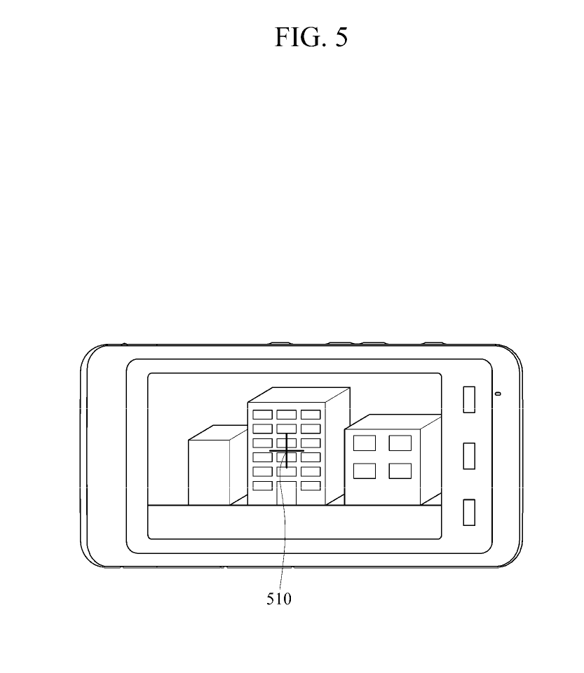

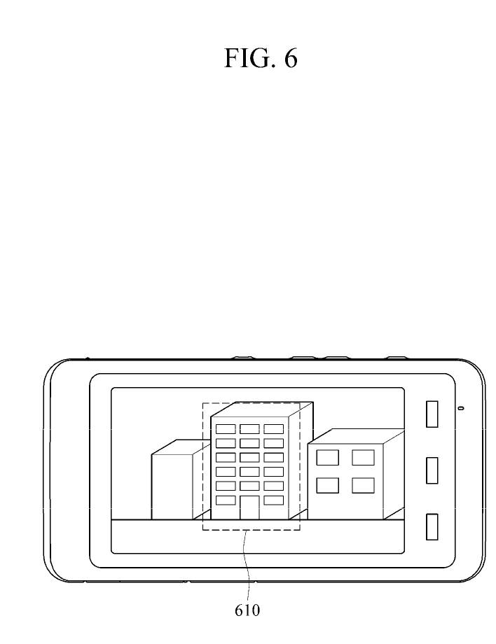

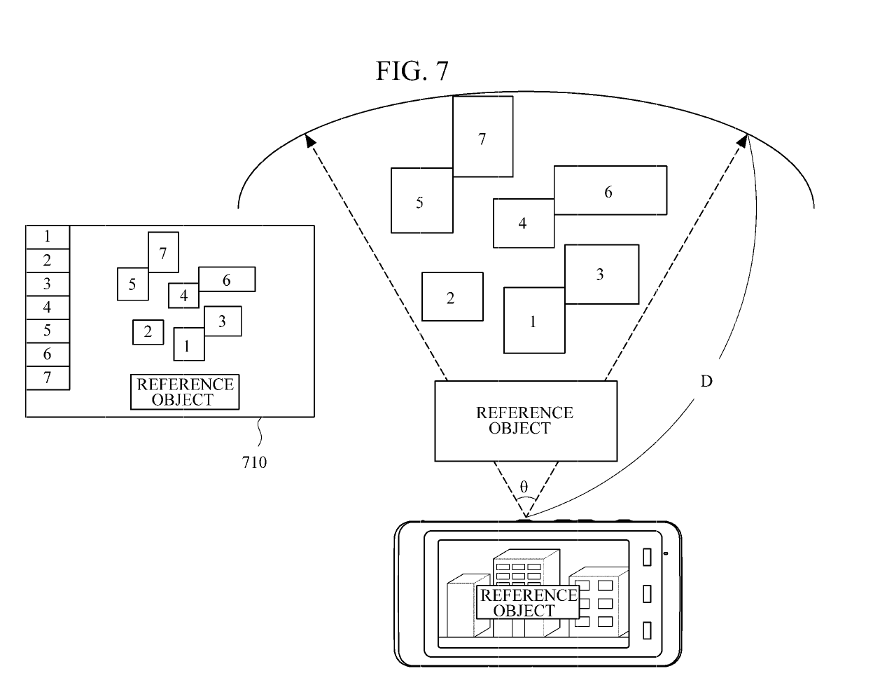

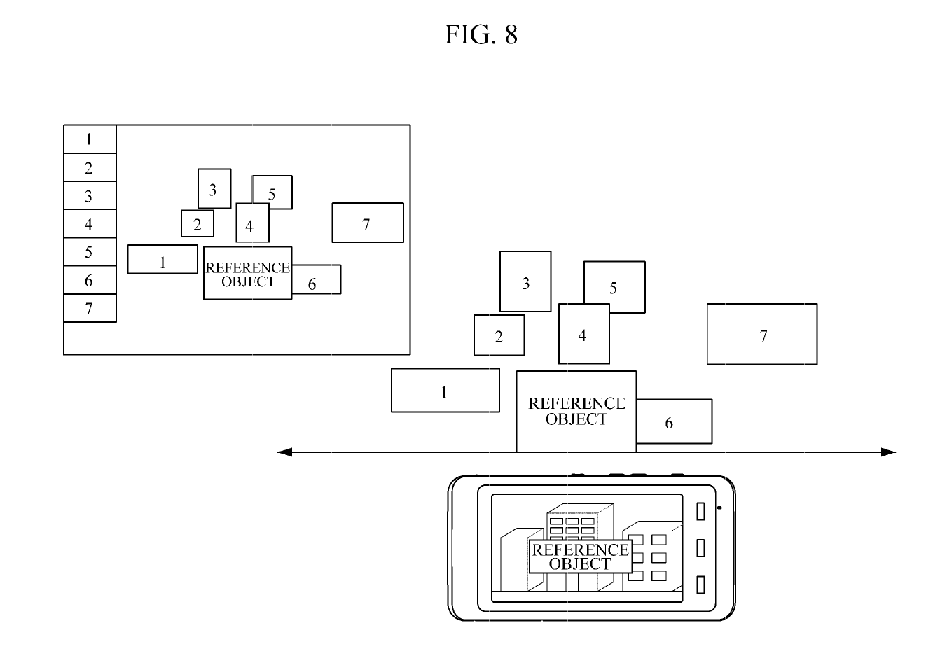

FIG. 4 is a flowchart for a method of providing AR information according to an exemplary embodiment, FIG. 5 is a diagram illustrating a focal point setting screen according to an exemplary embodiment, FIG. 6 is a diagram illustrating a focal point setting screen according to an exemplary embodiment, FIG. 7 is a diagram illustrating a user interface to provide concealed object information according to an exemplary embodiment, and FIG. 8 is a diagram illustrating a user interface to provide concealed object information according to an exemplary embodiment.

Referring to FIG. 4, at 405, the terminal drives the image acquiring unit 210 to acquire an image of the real environment, and outputs the acquired image to the display unit 220. The terminal may control the image acquiring unit 210 to acquire the image in response to an input from the manipulating unit 240; however, aspects are not limited thereto such that the image acquiring unit 210 may automatically acquire such image. At 410, the terminal receives an AR information request with respect to a concealed object that is not shown because, for example, another object in the image is in front of or conceals the object, and then, at 415, the terminal defines a reference object from among one or more visible objects included in the acquired image.

There may be various examples of how to define a reference object at 415.

For example, the terminal may select and define a reference object according to previously set criteria, and as an example, the most visible object among the visible objects may be set as the reference object.

For another example, the reference object may be set by selection information input from the user. A cross-shaped focal point 510 as shown in FIG. 5 or a rectangular focal area 610 as shown in the example illustrated in FIG. 6 may be display on a screen, and the user may apply focal point adjustment information in connection with a reference object selected by the user to the created focal point or area, and then select a visible object located or disposed at the focal point or area as the reference object according to the focal point adjustment information. For another example, the user may directly touch the screen to input reference object selection information.

At 420, the terminal obtains recognition information of the reference object. For example, property information (i.e., outline and/or color) of a real object, which may be an object of interest, is extracted from an image acquired from a camera as recognition information.

At 425, the terminal obtains position information about a position at which the acquired image is or was captured. If the image is obtained by the terminal in real-time, the terminal may obtain its position information from the position determination system. However, if the image is previously obtained or provided from an external source, the terminal may receive image capturing position information from the user or from data regarding or within the image. Here, operations 420 and 425 may be performed simultaneously, or the order of operations 420 and 425 may be rearranged.

At 430, the terminal issues a concealed object information request to the server. In this case, the terminal may transmit reference object recognition information and image capturing position information. In addition to the reference object recognition information and the image capturing position information, information about a range of the concealed object may be transmitted, and, for example, referring to FIG. 7, the range information may include a depth D from an image capturing position to the reference object along and/or about an image capturing direction of the terminal and an angle of view θ at the image capturing position. Although not illustrated, the range information of the concealed object may be previously defined or be input in real-time by the user. If the server has previously defined the range information, the range information may not be transmitted from the terminal.

In response to receiving the concealed object information request from the terminal, the server analyzes the received reference object recognition information and the image capturing position information at 435. More specifically, the server searches the map information storage unit 340 (see FIG. 3) to detect or determine a map corresponding to the received image capturing position information, and analyzes the reference object recognition information to determine the position of the reference object on the detected map. The server uses the determined reference object position and the image capturing position information to obtain information about an image capturing direction. For example, the image capturing direction may be a direction from the image capturing position to the reference object may be determined as the image capturing direction, and the image capturing direction may be determined from the reference object recognition information, the image capturing position information, and the like, and/or may be determined gyroscopically.

At 440, the server detects or determines information about concealed objects positioned behind the reference object along and/or about the direction from the image capturing position to the reference object, that is, the image capturing direction, according to the analysis result obtained at 435. The server may detect or determine information about concealed objects present within a range determined by the above described depth D and angle of view θ and the image capturing direction obtained at 435. For example, referring to FIG. 6, seven concealed objects may be determine.

The server transmits the determined information about concealed objects to the terminal at 445. The information about concealed objects may be displayed in or as a user interface 710 as shown in FIG. 7, which displays positions and, additionally, sizes of the concealed objects with respect to the reference object.

However, aspects are not limited thereto such that various modifications of the above user interface may be made, and for example, in order to identify the concealed objects, the user interface may assign identification numbers to the respective concealed objects as shown in FIG. 7, display the respective concealed objects with different colors, or allocate identifiers to the respective concealed objects.

There may be various methods of assigning the identification numbers. For example, as shown in FIG. 7, the identification numbers may be sequentially assigned to the concealed objects, starting from the concealed object closest to the reference object to the concealed object farthest from the reference position along and/or about the image capturing direction. For example, as shown in FIG. 8, the identification numbers may be assigned to the concealed objects in a clockwise direction.

The terminal outputs the concealed object information to the display unit 220 (see FIG. 2) at 445. For example, the concealed object information output to the display unit 220 may be displayed as the user interface 710 on the whole screen of the display unit 220 as shown in FIG. 7, may be displayed on a region of the screen which is displaying a preview image, or may be displayed in the form of a popup window. Additionally, the user interface 710 may be varied according to information input from the user.

At 455, object of interest selection information about an object of interest for which AR information is to be obtained from among the output concealed objects is received through the manipulating unit 240. The method of receiving the object of interest selection information may be varied in different embodiments. For example, the user may touch the screen to select an object of interest, or may directly input identification information of the object of interest, such as an identification number, an identifier, and identification color. In response to receiving the object of interest selection information from the user, the terminal transmits the received object of interest selection information to the server at 460. That is, the terminal determines identification information of the object of interest and transmits it to the server.

At 465, the server detects or determines AR information related to an object corresponding to the object of interest selection information transmitted from the terminal.

At 480, in response to receiving the AR information from the server, the terminal displays the received AR information combined with the corresponding object of interest. However, since the object of interest is a concealed object, the object of interest may be displayed overlaying on a preview image, or information about the object of interest may be displayed on a part of the preview image.

As described above, AR information can be provided with respect to a concealed object that is behind or concealed by other objects and thus cannot be recognized by a camera.

Although the examples above are described as being implemented in a system that is configured to include an AR information provision terminal apparatus and an AR information provision server which are connected to each other through a communication network, the terminal and server may be implemented as being integrated into a single apparatus.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for providing augmented information (AR) of a concealed object by a terminal connectable to a server via a wired and/or wireless communication network, the method comprising:
acquiring an image of a real environment;
defining a reference object included in the acquired image;
obtaining image capturing position information about a position of the image and reference object recognition information of the defined reference object;
transmitting the obtained image capturing position information and the reference object recognition information to the server;
receiving information about concealed objects from the server, the concealed objects being disposed behind the reference object about a direction from the image capturing position to the reference object; and
outputting the received information about concealed objects.

2. The method of claim 1, wherein the defining of the reference object comprises:
receiving reference object selection information from a user.

3. The method of claim 1, wherein the defining of the reference object comprises:
creating a focal point on a screen on which the image is output; and
defining an object located at the focal point as the reference object.

4. The method of claim 1, wherein the information about concealed objects is information of concealed objects which are present within a range defined based on the reference object.

5. The method of claim 4, wherein the range is determined by a depth and an angle of view in the direction from the image capturing position to the reference object.

6. The method of claim 1, wherein the information about concealed objects is user interface information that includes positions of concealed objects with respect to the reference object.

7. The method of claim 6, wherein the concealed objects are represented in the user interface information by different identification numbers or colors for individual concealed objects.

8. The method of claim 1, further comprising:
in response to receiving object of interest selection information about an object of interest selected from concealed objects, obtaining AR information corresponding to the object of interest; and
outputting the obtained AR information.

9. A method for providing augmented reality (AR) information of a concealed object by a server connected to at least one or more terminals via a wired and/or wireless communication network, the method comprising:
in response to receiving a concealed object information request from one of the terminals, analyzing reference object recognition information and image capturing position information received from the terminal;
determining information about at least one or more concealed objects disposed behind a reference object about a direction from an image capturing position to the reference object according to the analysis result; and
transmitting the determined information about the concealed objects to the terminal.

10. The method of claim 9, wherein the analyzing of the reference object recognition information and the image capturing position information comprises:
determining a map corresponding to the image capturing position information,
analyzing the reference object recognition information to determine a position of the reference object on the determined map, and
determining an image capturing direction according to the determined reference object position and the image capturing position.

11. The method of claim 9, wherein the determining of the information comprises determining concealed objects disposed within a range determined according to a depth and an angle of view in the obtained image capturing direction.

12. An apparatus to provide augmented reality (AR) information of a concealed object, the apparatus comprising:
an image acquiring unit to acquire an image of a real environment;
a display unit to output the image and information about a concealed object;
a communication unit to access a server and process a signal communicated with the server; and
a control unit to define a reference object included in the image, to obtain image capturing position information about a position of the image and reference object recognition information of the defined reference object, to transmit the obtained image capturing position information and reference object recognition information to the server through the communication unit, and to receive from the server information about concealed objects present about a direction from the image capturing position to the reference object, and to output the received information about concealed objects to the display unit.

13. The apparatus of claim 12, further comprising:
a manipulating unit to receive user information,
wherein the control unit receives reference object selection information from via the manipulating unit to define the reference object.

14. The apparatus of claim 13, wherein the control unit displays a focal point on the image output to the display unit and defines an object at the focal point as the reference object according to focal point adjustment information input from the manipulating unit.

15. The apparatus of claim 12, wherein the information about concealed objects is user interface information that includes positions of concealed objects with respect to the reference object.

16. The apparatus of claim 15, wherein the concealed objects are represented in the user interface information by different identification numbers or colors for individual concealed objects.

17. The apparatus of claim 13, wherein the control unit, in response to receiving selection information about an object of interest selected from concealed objects, obtains AR information corresponding to the selected object of interest from the server, and outputs the obtained AR information to the display unit.

18. A server to provide augmented reality (AR) information of a concealed object, the server comprising:
a communication unit to process a signal communicated with at least one or more terminals via a wired and/or wireless communication network; and
a control unit to, in response to receiving concealed object information request signal from the terminal through the communication unit, analyze reference object recognition information and image capturing position information received from the terminal, to determine information about at least one or more concealed objects that are disposed behind a reference object about a direction from an image capturing position to the reference object according to the analysis result, and to transmit the determined information about concealed objects to the terminal.

19. The server of claim 18, further comprising:
a map information storage unit to store map information,
wherein the control unit determines a map from the map information storage unit corresponding to the received image capturing position information, analyzes the reference object recognition information to determine a position of the reference object on the determined map, and obtains an image capturing direction according to the determined reference object position and the image capturing position information.

20. The server of claim 19, wherein the control unit determines concealed objects disposed within a range determined according to a depth and an angle of view in the obtained image capturing direction.
